(19) United States
(12) Patent Application Publication
(10) Pub. No.: US 2012/0068826 A1
(43) Pub. Date: Mar. 22, 2012

(54) Directional Radio Frequency Identification (RFID) Label Tag For Measuring Postal Matter Delivery Service

(75) Inventor: Ki Hak Kim, Daejeon (KR)

(73) Assignee: ELECTRONICS AND TELECOMMUNICATIONS RESEARCH INSTITUTE, Daejeon (KR)

(21) Appl. No.: 13/189,927

(22) Filed: Jul. 25, 2011

(30) Foreign Application Priority Data
Sep. 17, 2010 (KR) 10-2010-0091657

(51) Int. Cl. H04Q 5/22; B32B 37/02

(52) U.S. Cl. 340/10.1; 156/64

(57) ABSTRACT

Provided are a Radio Frequency Identification (RFID) tag, a method of manufacturing the RFID system, and an RFID system. The RFID tag may include a plurality of tag units. An input impedance of a tag antenna may be matched based on a coupling characteristic of the plurality of tag units, and a radiation pattern of the tag antenna may be set.

### CROSS-REFERENCE TO RELATED APPLICATION

This application claims the benefit of Korean Patent Application No. 10-2010-0091657, filed on Sep. 17, 2010, in the Korean Intellectual Property Office, the disclosure of which is incorporated herein by reference.

### BACKGROUND

1. Field of the Invention

The present invention relates to a Radio Frequency Identification (RFID) tag, a method of manufacturing the RFID tag, and an RFID system.

2. Description of the Related Art

A Radio Frequency Identification (RFID) system indicates a system that may identify a tag attached to an object using a non-contact scheme, for example, a radio signal, and may process information, for example, a name of the object, a price of the object, an expiry date of the object, and the like.

In general, the RFID system includes a reader, a reader antenna, and a tag or a transponder.

The tag may include a tag antenna and a tag chip. The tag chip corresponds to an integrated circuit storing information.

When the tag enters into a recognition range, an RFID reader may modulate a radio frequency (RF) signal having a predetermined carrier frequency and transmit a radio signal to the tag. When the tag receives the radio signal, the tag may respond to the radio signal. For example, the tag chip may transmit stored information as a radio signal via the tag antenna. The reader antenna may receive the radio signal, and the reader may read the information using the received radio signal.

The RFID system may have a different applicable portion, standard technology, and the like, depending on an operating frequency.

Among a plurality of frequency bands of RFID, an Ultra High Frequency (UHF) band may provide a high operating frequency. The RFID system of the UHF band may perform transmission and reception between the RFID reader and the RFID tag at a relatively remote location. Also, the RFID reader using the UHF band may simultaneously recognize a plurality of RFID tags. Accordingly, the RFID system using the UHF band has been widely used in distribution and circulation fields.

In the RFID system using the UHF band, the RFID tag may be classified into an active label tag including a battery and a passive label tag not including the battery.

The passive label tag corresponds to a dipole type. In general, the passive label tag is designed to form a radiation pattern of every direction and to be recognized in a predetermined direction.

When a facing angle between the RFID tag and the reader antenna is fixed, it may be more advantageous in a recognition rate aspect to form the radiation pattern of the RFID tag to face the reader antenna, compared to form the radiation pattern to face all the directions.

The RFID system has been used in every country to measure a delivery service quality with respect to a postal matter. In Korea, various apparatuses have been employed to measure the quality of the delivery service. However, a postal matter enclosed with a corresponding apparatus may have a significantly thick appearance compared to other postal matters and thus, may be easily disclosed as a target for the quality measurement.

### SUMMARY

According to an aspect of the present invention, there is provided a Radio Frequency Identification (RFID) tag, including: a first tag unit; a second tag unit; and an adhesion plate where the first tag unit and the second tag unit are attached.

The first tag unit may include: a first tag antenna to determine a resonance frequency of the first tag unit; a first tag chip to store first information; and a first feed line being connected to the first tag antenna to supply a power to the first tag chip.

The second tag unit may include: a second tag antenna to determine a resonance frequency of the second tag unit; a second tag chip to store second information; and a second feed line being connected to the second tag antenna to supply a power to the second tag chip.

The first tag antenna and the second tag antenna may operate using a coupling characteristic between the first tag antenna and the second tag antenna.

The adhesion plate may use a flexible material.

The coupling characteristic may indicate that a radiation pattern of each of the first tag antenna and the second tag antenna is formed into a predetermined direction.

The radiation pattern may be formed into a parallel direction with a tag surface of the first tag antenna and the second tag antenna.

An interval between the first tag antenna and the second tag antenna may be determined based on a resistance component of an input impedance of each of the first tag antenna and the second tag antenna required for operation of the RFID tag.

The coupling characteristic may indicate that a reactance component of an input impedance of each of the first tag antenna and the second tag antenna is determined independently with respect to an interval between the first tag antenna and the second tag antenna.

A slot interval of the first feed line and a slot interval of the second feed line may be determined based on a reactance component of an input impedance of each of the first tag antenna and the second tag antenna required for operation of the RFID tag.

When the RFID tag is positioned within a recognition range of a reader antenna, a tag unit relatively close to the reader antenna between the first tag unit and the second tag unit may operate as a director and a tag unit relatively away from the reader antenna may be activated as the RFID tag.

According to another aspect of the present invention, there is provided a method of manufacturing a Radio Frequency Identification (RFID) tag comprising a first tag unit, a second tag unit, and an adhesion plate, the method including: determining a first setup value that is a slot interval of each of a first feed line of the first tag unit and a second feed line of the second tag unit based on a reactance component of an input impedance required for operation of the RFID tag; determining a second setup value that is an interval between a first tag antenna of the first tag unit and a second tag antenna of the second tag unit based on a resistance component of the input impedance required for operation of the RFID tag; and attaching, to the adhesion plate, the first tag unit comprising the first feed line according to the first setup value and the second tag unit comprising the second feed line according to the first setup value to have an interval according to the second setup value.

According to still another aspect of the present invention, there is provided a Radio Frequency Identification (RFID) system, including: an RFID tag comprising a first tag unit, a second tag unit, and an adhesion plate; a reader antenna to receive a radio signal from the RFID tag; and a reader to extract tag information in the received radio signal.

A radiation pattern of each of the first tag antenna and the second tag antenna may be directional. The first tag unit and the second tag unit may be attached to the adhesion plate to maximize a directivity towards a facing angle between the reader antenna and the RFID tag.

According to embodiments of the present invention, there may be provided an RFID tag that may match an input impedance using a coupling characteristic of a plurality of tag units and set a radiation pattern into a predetermined direction, a method of manufacturing the RFID tag, and an RFID system.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a configuration diagram of a Radio Frequency Identification (RFID) system according to an embodiment of the present invention;

FIG. 2 is a diagram illustrating a configuration of an RFID tag according to an embodiment of the present invention;

FIG. 3 is a graph illustrating a resistance component of an input impedance of a tag antenna according to an embodiment of the present invention;

FIG. 4 is a graph illustrating a reactance component of an input impedance of a tag antenna according to an embodiment of the present invention;

FIG. 5 is a graph illustrating a reactance component of an input impedance of a tag antenna according to an embodiment of the present invention;

FIG. 6 is a diagram illustrating a radiation pattern when a first tag unit is activated according to an embodiment of the present invention;

FIG. 7 is a diagram illustrating a radiation pattern when a second tag unit is activated according to an embodiment of the present invention; and

FIG. 8 is a flowchart illustrating a method of manufacturing an RFID tag according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

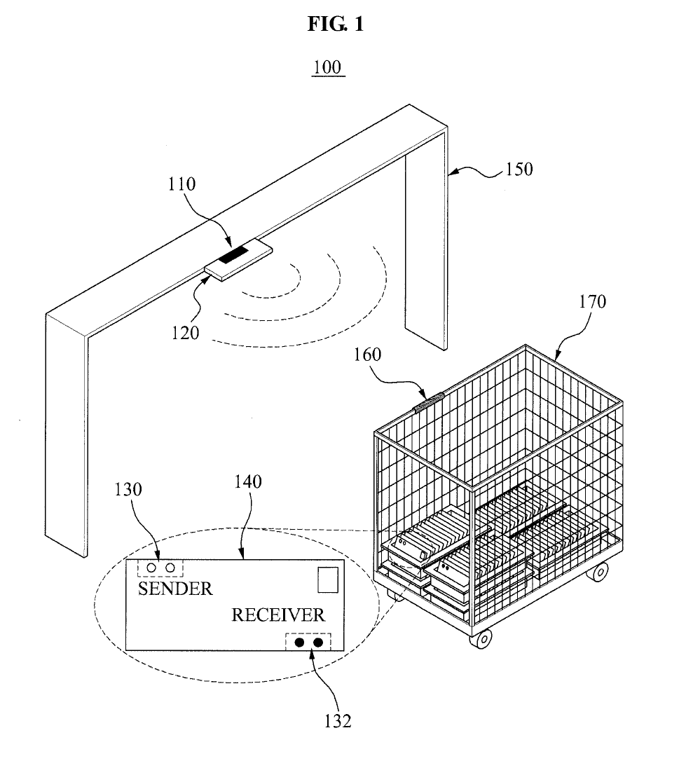

FIG. 1 is a configuration diagram of a Radio Frequency Identification (RFID) system 100 according to an embodiment of the present invention. The RFID system 100 may include an RFID reader 110, an RFID reader antenna 120, and an RFID tag 130.

The RFID reader antenna 120 may receive a radio signal from the RFID tag 130.

The RFID reader 110 may receive the radio signal from the RFID reader antenna 120 and extract tag information in the received radio signal.

The RFID tag 130 may be activated within a recognition range of the RFID reader antenna 120 and transmit the radio signal.

The RFID reader 110 and the RFID reader antenna 120 may be attached to a gate 150 to thereby operate at an appropriate position.

In general, the RFID tag 130 may be attached to an article 140 associated with information transmitted from the RFID tag 130 and thereby be used. For example, the article 130 may be a postal matter. The RFID tag 130 may provide information, for example, a sender address, a delivery address, a received date, a received post office, an estimated arrival date, a fee, a type, a weight, and the like with respect to the postal matter.

The article 140 may be transported with being contained in a transport container 160, for example, a pallet for transporting postal matters. The transport container 160 may include, for example, a metal tag 170 for the transport container 160 to stably load the article 140.

Based on a location of the RFID tag 130 attached to the article 140 and a direction of the article 140 loaded to the transport container 160, the RFID tag 130 may be occluded by other articles within the transport container 160, and the like. Accordingly, a plurality of RFID tags, for example, the RFID tags 130 and 132 may be attached to the article 130 at relative locations. Among the plurality of RFID tags, an RFID tag receiving relatively less jamming, for example, being positioned to be relatively above or not being occluded by other articles, may initially operate.

When the article 140 is loaded to the predetermined transport container 160, the article 140 may be loaded into a predetermined direction. For example, in FIG. 1, the article 140 attached with the RFID tag 130 is loaded vertically with respect to a ground surface.

When the RFID tag 130 is used to measure a quality of the enclosed article 140, for example, a postal matter, a dipole type of a common tag generally used as the RFID tag 130 may have a radiation pattern of every direction. Accordingly, interference between RFID tags may occur. A recognition rate of the RFID tag 130 may be deteriorated. Also, all directions of the transport container 160 may be blocked by the metal tag 170 and the like. In this case, even though antennas are installed on both sides of the gate 150, the recognition rate of the RFID tag 130 may not be improved.

As the transport container 160 approaches the RFID reader antenna 120, the RFID tag 130 may enter into the recognition range of the RFID reader antenna 120. In this instance, a facing angle between the RFID reader antenna 120 and the RFID tag 130 may be constant. In this case, when the RFID tag 130 forms a radiation pattern into a predetermined direction, that is, to have a directivity, the recognition rate of the RFID tag 130 may be improved.

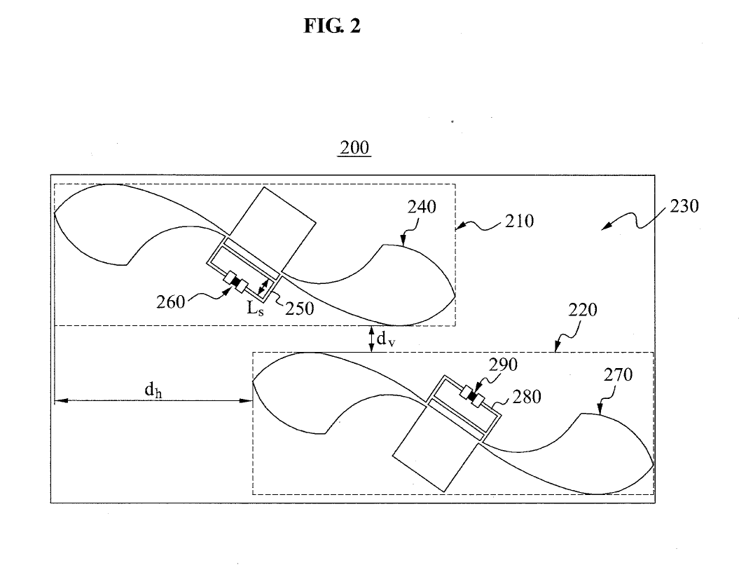

Hereinafter, an example of a configuration of an RFID tag will be described with reference to FIG. 2.

FIG. 2 is a diagram illustrating a configuration of an RFID tag 200 according to an embodiment of the present invention.

The RFID tag 200 (hereinafter, tag 200) may include a first tag unit 210, a second tag unit 220, and an adhesion plate 230.

The first tag unit 210 and the second tag unit 220 may be attached to the adhesion plate 230 and thereby be fixed. The first tag unit 210 and the second tag unit 220 may be formed on the adhesion plate 230.

The adhesion plate 230 may generally have an even surface. The adhesion plate 230 may use a flexible material, and may be a flexible printed circuit board (FPCB). The adhesion plate 230 may have a predetermined size, for example, 18 cm×19 cm, for a characteristic and a purpose of a product to be attached with the tag 200.

The first tag unit 210 may include a first tag antenna 240, a first feed line 250, and a first tag chip 260.

The first tag antenna 240 may have a resonance frequency required for operation of the tag 200 based on a characteristic, for example, a length of the first tag unit 210 or the first tag antenna 240.

The first feed line 250 may be connected to the first tag antenna 240 to supply a power to the first tag chip 260.

The first tag chip 260 may store information, for example, information associated with a product attached with the tag 200, and may provide the information.

The second tag unit 220 may include a second tag antenna 270, a second feed line 280, and a second tag chip 290.

The second tag antenna 270 may have a resonance frequency required for operation of the tag 200 based on a characteristic, for example, a length of the second tag unit 220 or the second tag antenna 270.

The second feed line 280 may be connected to the second tag antenna 270 to supply a power to the second tag chip 290.

The second tag chip 290 may store information, for example, information associated with a product attached with the tag 200, and may provide the information. The information provided by the first tag chip 260 may be the same as the information provided by the second tag chip 290.

The first tag antenna 240 and the second tag antenna 270 or the first tag unit 210 and the second tag unit 220 may operate using a coupling characteristic between the first tag antenna 240 and the second tag antenna 270.

Due to the coupling characteristic, the first tag antenna 240 and the second tag antenna 270 may form a radiation pattern into a predetermined direction.

That is, unlike an existing dipole antenna forming the radiation pattern into every direction, the first tag antenna 240 and the second tag antenna 270 may form the radiation pattern into a parallel direction with a tag surface, that is, into a vertical direction or a horizontal direction.

The radiation pattern may be vertically formed on the tag surface. Therefore, when the RFID system 100 is used for a central postal station, the tag 200 and the RFID system 100 may be used to measure the delivery service quality with respect to general postal matters.

When the first tag unit 210 and the second tag unit 220 enter into the recognition range of the RFID reader antenna 120, a tag relatively close to the RFID reader antenna 120 between the first tag antenna 240 and the second tag antenna 270 may operate as a director and a tag relatively away from the RFID reader antenna 120 may be activated as the RFID tag 130.

To increase the recognition rate of the tag 200, the first tag unit 210 and the second tag unit 220 or the first tag antenna 240 and the second tag antenna 270 may be attached to the adhesion plate 230 to maximize a directivity towards a facing angle between the RFID reader antenna 120 and the tag 200.

The first tag unit 210, the second tag unit 220, the first tag antenna 240, or the second tag antenna 270 may be a dipole type. The tag 200 may be used for the RFID system 100 using the transport container 160.

The first tag antenna 240 and the second tag antenna 270 of FIG. 2 are only examples and thus, the present invention is not limited thereto. Specifically, two or at least two tag antennas having a predetermined shape, for example, a radiation element shape, a similar radiation element shape, and the like that may be used as an RFID tag antenna, the coupling characteristic of the tag antennas, and a predetermined radiation pattern formed by the coupling characteristic may be included.

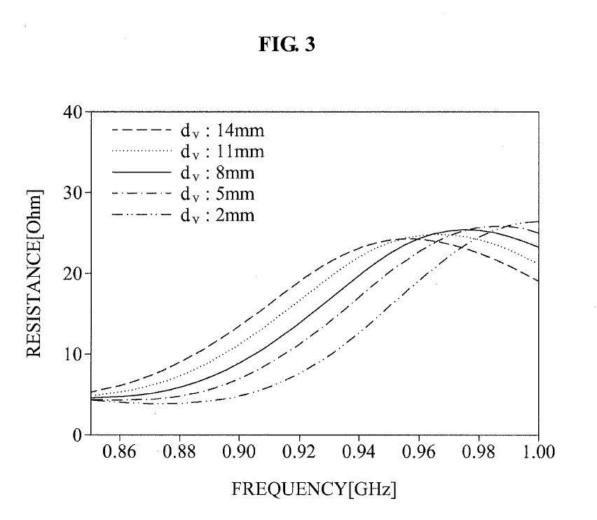

FIG. 3 is a graph illustrating a resistance component of an input impedance of a tag antenna according to an embodiment of the present invention.

In the graph of FIG. 3, an x axis denotes a frequency (GHz unit), and an y axis denotes resistance (Ohm unit) of an input impedance of a tag antenna, for example, each of the first tag antenna 240 and the second tag antenna 270.

dᵥ denotes an interval between the first tag antenna 240 and the second tag antenna 270 or an interval between the first tag unit 210 and the second tag unit 220. dᵥ may denote a vertical distance between the first tag antenna 240 and the second tag antenna 270, that is, a difference, for example, dᵥ of FIG. 2 between y coordinates of a bottom end of the first tag antenna 240 and y coordinates of a top end of the second tag antenna 270.

FIG. 3 illustrates a resistance characteristic when dᵥ is 14 mm, 11 mm, 8 mm, 5 mm, or 2 mm.

As shown in FIG. 3, a resistance component of an input impedance of each of the first tag antenna 240 and the second tag antenna 270 may vary according to a change in dᵥ. According to an increase in dᵥ, the resistance component of the input impedance of each of the first tag antenna 240 and the second tag antenna 270 may increase.

Accordingly, the interval between the first tag antenna 240 and the second tag antenna 270 or the interval between the first tag unit 210 and the second tag unit 220 may be determined based on the resistance component of the input impedance of each of the first tag antenna 240 and the second tag antenna 270 required for operation of the tag 200.

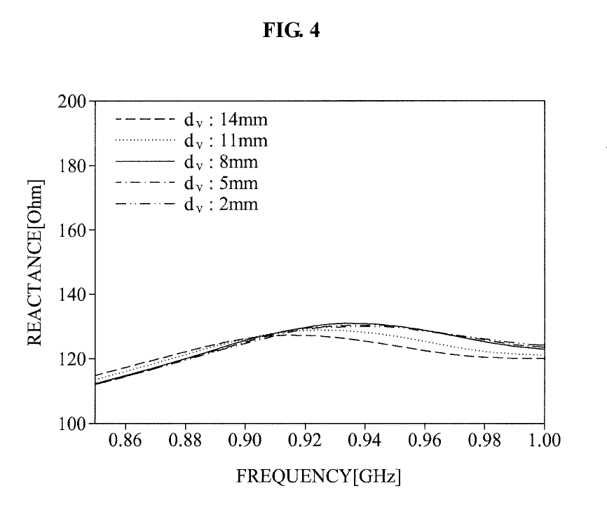

FIG. 4 is a graph illustrating a reactance component of an input impedance of a tag antenna according to an embodiment of the present invention.

In the graph of FIG. 4, an x axis denotes a frequency (GHz unit), and an y axis denotes reactance (Ohm unit) of an input impedance of a tag antenna, for example, each of the first tag antenna 240 and the second tag antenna 270.

dᵥ may refer to descriptions made above with reference to FIG. 3.

As shown in FIG. 4, even though dᵥ varies, the reactance component of the input impedance of each of the first tag antenna 240 and the second tag antenna 270 may be constantly maintained.

Accordingly, even though dᵥ varies in order to adjust the resistance component of the input impedance of each of the first tag antenna 240 and the second tag antenna 270 as described above with reference to FIG. 3, the reactance component of the input impedance of each of the first tag antenna 240 and the second tag antenna 270 may rarely vary. Specifically, the reactance component of the input impedance of each of the first tag antenna 240 and the second tag antenna 270 may be determined independently with respect to the interval dᵥ between the first tag antenna 240 and the second tag antenna 270.

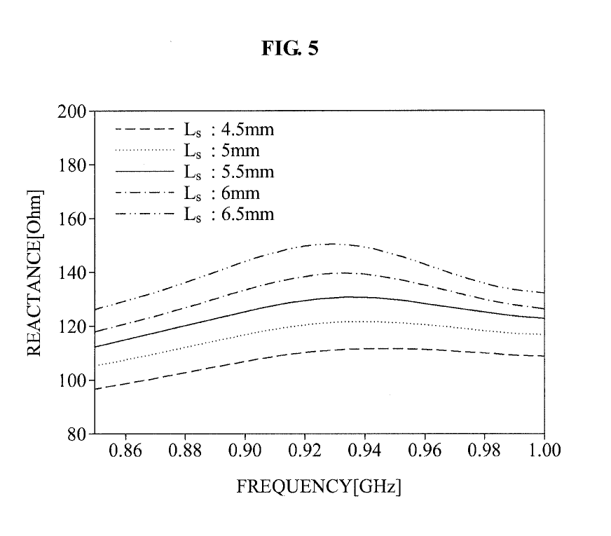

FIG. 5 is a graph illustrating a reactance component of an input impedance of a tag antenna according to an embodiment of the present invention.

In the graph of FIG. 5, an x axis denotes a frequency (GHz unit), and an y axis denotes reactance (Ohm unit) of an input impedance of a tag antenna, for example, each of the first tag antenna 240 and the second tag antenna 270.

Lₛ denotes a slot interval of the first feed line 250 of FIG. 2 and a slot interval of the second feed line 260.

FIG. 5 illustrates a reactance characteristic when Lₛ is 4.5 mm, 5 mm, 5.5 mm, 6 mm, or 6.5 mm.

As shown in FIG. 5, the reactance component of the input impedance of each of the first tag antenna 240 and the second tag antenna 270 may vary according to a change in Lₛ. According to an increase in Lₛ, the reactance component of the input impedance of each of the first tag antenna 240 and the second tag antenna 270 may increase.

Accordingly, the slot interval of the first feed line 250 and the slot interval of the second feed line 260 may be determined based on the reactance component of the input impedance of each of the first tag antenna 240 and the second tag antenna 270 required for operation of the tag 200.

The impedance of each of the first tag antenna 240 and the second tag antenna 270 may be approximately matched with an input impedance of each of the first tag chip 260 and the second tag chip 290. For the above matching, dᵥ and Lₛ may be adjusted. In addition, to maintain an appropriate interval between the first tag unit 210 and the second tag unit 220 without significantly changing the matched input impedance, that is, to adjust a position within the adhesion plate 230, a horizontal interval, for example, dₕ of FIG. 2 between the first tag unit 210 and the second tag unit 220 or between the first tag antenna 240 and the second tag antenna 270 may be adjusted.

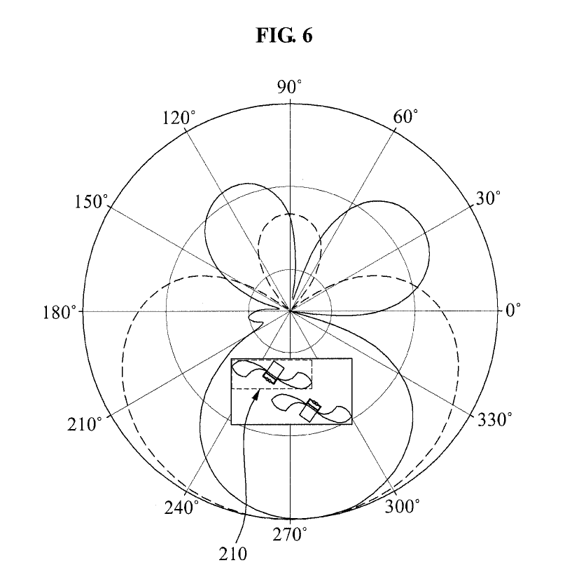

FIG. 6 is a diagram illustrating a radiation pattern when a first tag unit 210 is activated according to an embodiment of the present invention.

FIG. 6 illustrates a radiation pattern of the first tag antenna 240 or the first tag unit 210 with respect to an x-y plane. As shown in FIG. 6, the first tag antenna 240 may have a directivity towards a direction where the second tag unit 220 is provided. Here, the second tag antenna 270 or the second tag unit 220 may perform a functionality of a director.

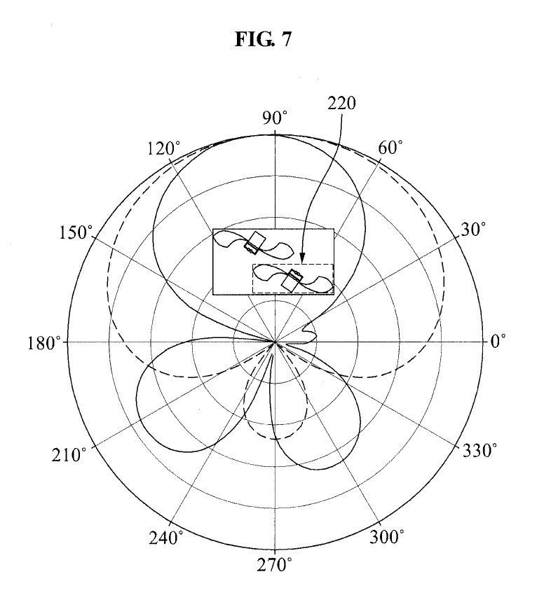

FIG. 7 is a diagram illustrating a radiation pattern when a second tag unit 220 is activated according to an embodiment of the present invention.

FIG. 7 illustrates a radiation pattern of the second tag antenna 270 or the second tag unit 220 with respect to an x-y plane. As shown in FIG. 7, the second tag antenna 270 may have a directivity towards a direction where the first tag unit 210 is provided. Here, the first tag antenna 240 or the first tag unit 210 may perform a functionality of a director.

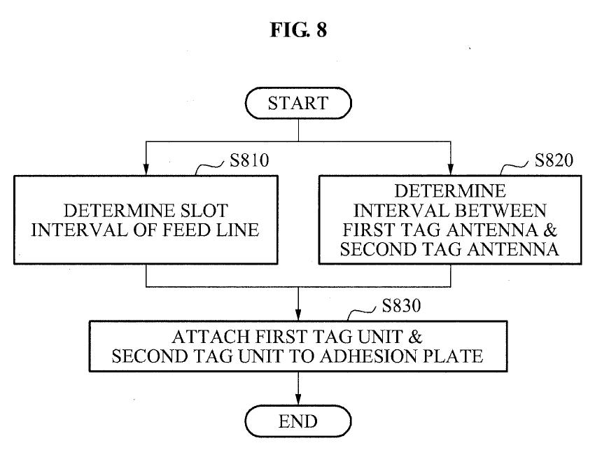

FIG. 8 is a flowchart illustrating a method of manufacturing an RFID tag according to an embodiment of the present invention.

In operation 810, a first setup value may be determined based on a reactance component of an input impedance required for operation of the RFID tag. The first setup value may be a slot interval of each of the first feed line 250 of the first tag unit 210 and the second feed line 280 of the second tag unit 220.

In operation 820, a second setup value may be determined based on a resistance component of the input impedance required for operation of the RFID tag. The second setup value may be an interval between the first tag antenna 240 of the first tag unit 210 and a second tag antenna 270 of the second tag unit 220.

In operation 830, the first tag unit 210 including the first feed line 250 according to the first setup value and the second tag unit 220 including the second feed line 280 according to the first setup value may be attached to the adhesion plate 230 to have an interval according to the second setup value.

Descriptions made above with reference to FIG. 1 through FIG. 7 may be applicable to the present embodiment and thus, further detailed descriptions will be omitted here.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A Radio Frequency Identification (RFID) tag, comprising:
a first tag unit;
a second tag unit; and
an adhesion plate where the first tag unit and the second tag unit are attached,
wherein the first tag unit comprises:
a first tag antenna to determine a resonance frequency of the first tag unit;
a first tag chip to store first information; and
a first feed line being connected to the first tag antenna to supply a power to the first tag chip, and
the second tag unit comprises:
a second tag antenna to determine a resonance frequency of the second tag unit;
a second tag chip to store second information; and
a second feed line being connected to the second tag antenna to supply a power to the second tag chip, and
the first tag antenna and the second tag antenna operate using a coupling characteristic between the first tag antenna and the second tag antenna.

2. The RFID tag of claim 1, wherein the adhesion plate uses a flexible material.

3. The RFID tag of claim 1, wherein the coupling characteristic indicates that a radiation pattern of each of the first tag antenna and the second tag antenna is formed into a predetermined direction.

4. The RFID tag of claim 3, wherein the radiation pattern is formed into a parallel direction with a tag surface of the first tag antenna and the second tag antenna.

5. The RFID tag of claim 1, wherein an interval between the first tag antenna and the second tag antenna is determined based on a resistance component of an input impedance of each of the first tag antenna and the second tag antenna required for operation of the RFID tag.

6. The RFID tag of claim 1, wherein the coupling characteristic indicates that a reactance component of an input impedance of each of the first tag antenna and the second tag antenna is determined independently with respect to an interval between the first tag antenna and the second tag antenna.

7. The RFID tag of claim 1, wherein a slot interval of the first feed line and a slot interval of the second feed line are determined based on a reactance component of an input impedance of each of the first tag antenna and the second tag antenna required for operation of the RFID tag.

8. The RFID tag of claim 1, wherein when the RFID tag is positioned within a recognition range of a reader antenna, a tag unit relatively close to the reader antenna between the first tag unit and the second tag unit operates as a director and a tag unit relatively away from the reader antenna is activated as the RFID tag.

9. A method of manufacturing a Radio Frequency Identification (RFID) tag comprising a first tag unit, a second tag unit, and an adhesion plate, the method comprising:
determining a first setup value that is a slot interval of each of a first feed line of the first tag unit and a second feed line of the second tag unit based on a reactance component of an input impedance required for operation of the RFID tag;
determining a second setup value that is an interval between a first tag antenna of the first tag unit and a second tag antenna of the second tag unit based on a resistance component of the input impedance required for operation of the RFID tag; and
attaching, to the adhesion plate, the first tag unit comprising the first feed line according to the first setup value and the second tag unit comprising the second feed line according to the first setup value to have an interval according to the second setup value.

10. A Radio Frequency Identification (RFID) system, comprising:
an RFID tag comprising a first tag unit, a second tag unit, and an adhesion plate;
a reader antenna to receive a radio signal from the RFID tag; and
a reader to extract tag information in the received radio signal,
wherein the adhesion plate fixes a location of each of the first tag unit and the second tag unit,
the first tag unit comprises:
a first tag antenna to determine a resonance frequency of the first tag unit;
a first tag chip to store the tag information; and
a first feed line being connected to the first tag antenna to supply a power to the first tag chip,
the second tag unit comprises:
a second tag antenna to determine a resonance frequency of the second tag unit;
a second tag chip to store the tag information; and
a second feed line being connected to the second tag antenna to supply a power to the second tag chip, and
the first tag antenna and the second tag antenna perform a radio communication with the reader antenna using a coupling characteristic between the first tag unit and the second tag unit.

11. The RFID system of claim 10, wherein:
a radiation pattern of each of the first tag antenna and the second tag antenna is directional, and
the first tag unit and the second tag unit are attached to the adhesion plate to maximize a directivity towards a facing angle between the reader antenna and the RFID tag.
